(19) United States
(12) Patent Application Publication
(10) Pub. No.: US 2026/0260646 A1
(43) Pub. Date: Sep. 3, 2026

(54) ELECTRONIC APPARATUS AND CONTROLLING METHOD THEREOF

(71) Applicant: SAMSUNG ELECTRONICS CO, LTD., Suwon-si (KR)

(72) Inventors: Sangjun PARK, Suwon-si (KR); Heejin CHOI, Suwon-si (KR)

(73) Assignee: SAMSUNG ELECTRONICS CO, LTD., Suwon-si (KR)

(21) Appl. No.: 19/565,878

(22) Filed: Mar. 13, 2026

Related U.S. Application Data
(63) Continuation of application No. PCT/KR2026/001845, filed on Jan. 30, 2026.

(30) Foreign Application Priority Data
Feb. 28, 2025 (KR) 10-2025-0027079

(51) Int. Cl. G10L 13/033; G06F 40/58; G10L 17/02; G10L 17/06; G10L 21/003; G10L 21/0208; G10L 25/60

(52) U.S. Cl. CPC G10L 13/033; G06F 40/58; G10L 17/02; G10L 17/06; G10L 21/003; G10L 21/0208; G10L 25/60

(57) ABSTRACT

An electronic apparatus includes: memory storing instructions; and at least one processor including processing circuitry, wherein the instructions, when executed by the at least one processor individually or collectively, may cause the electronic apparatus to: based on an input voice signal corresponding to an utterance of a user being received, acquire quality information including a score indicating a level of quality of the input voice signal, based on the score being below a first threshold value, identify a registered voice signal for the user stored in the memory, based on the registered voice signal being identified, acquire a reference voice signal representing voice features of the user based on the registered voice signal, and acquire an output voice signal for the input voice signal based on input text corresponding to the input voice signal and the reference voice signal.

### CROSS-REFERENCE TO RELATED APPLICATIONS

This application is a bypass continuation application of International Application No. PCT/KR2026/001845, filed on January 30, 2026, which claims priority to Korean Patent Application No. 10-2025-0027079, filed on February 28, 2025, in the Korean Intellectual Property Office, the disclosure of which is incorporated by reference herein in its entirety.

### BACKGROUND

### 1. Field

The present disclosure relates to an electronic apparatus and a method for controlling an electronic apparatus, and more particularly, to an electronic apparatus capable of enhancing a reference voice signal used for synthesizing a user's voice, and a controlling method thereof.

### 2. Description of Related Art

Recently, with the advancement of artificial intelligence technologies, personalized text-to-speech (TTS) technologies capable of synthesizing speech that exhibits unique features of a user's voice have been developing. In particular, in the personalized speech synthesis, a technology (so called Zero-shot text-to-speech (TTS) or voice cloning) has been attracting attention. This technology synthesizes (generates) an output voice that reflects the unique features of the user's voice (reference voice) based on the input voice without any fine- tuning process when the user's voice is input or training of a neural network model using pre- registered voice data.

In the zero-shot TTS, when the quality of the input user's voice (in particular, the initial input user's voice) is high, a high-quality output voice may be acquired. However, in the zero-shot TTS, when the quality of the input user's voice is low, it is difficult to acquire a high-quality output voice.

For example, when the input user's voice is too short, it is difficult to express the user's timbre. When the input user's voice corresponds to an unstable utterance, the synthesized output voice may also be unstable. Likewise, when sounds other than the input user's voice are included, it becomes difficult to expect the high-quality output voice.

These limitations exist not only in the zero-shot TTS but also in technologies that utilize the reference voice for the user, such as voice conversion (VC), which transforms the user's voice into another user's voice.

### SUMMARY

Provided is an electronic apparatus capable of acquiring a high-quality output voice signal by enhancing a reference voice signal used for synthesizing a user's voice, and a controlling method thereof.

Additional aspects will be set forth in part in the description which follows and, in part, will be apparent from the description, or may be learned by practice of the presented embodiments.

According to an aspect of the disclosure, an electronic apparatus includes: memory storing instructions; and at least one processor including processing circuitry, wherein the instructions, when executed by the at least one processor individually or collectively, may cause the electronic apparatus to: based on an input voice signal corresponding to an utterance of a user being received, acquire quality information including a score indicating a level of quality of the input voice signal, based on the score being below a first threshold value, identify a registered voice signal for the user stored in the memory, based on the registered voice signal being identified, acquire a reference voice signal representing voice features of the user based on the registered voice signal, and acquire an output voice signal for the input voice signal based on input text corresponding to the input voice signal and the reference voice signal.

The instructions, when executed by the at least one processor individually or collectively, may cause the electronic apparatus to acquire the quality information based on at least one of a length of the input voice signal, a length of a voice portion included in the input voice signal, a length of a noise portion included in the input voice signal, or a frequency variation of the input voice signal.

The instructions, when executed by the at least one processor individually or collectively, may cause the electronic apparatus to, based on the score being greater than or equal to the first threshold value, acquire the input voice signal as the reference voice signal.

The instructions, when executed by the at least one processor individually or collectively, may cause the electronic apparatus to, based on the score being below the first threshold value and greater than or equal to a second threshold value that is less than the first threshold value, acquire the reference voice signal by concatenating the input voice signal and the registered voice signal.

The instructions, when executed by the at least one processor individually or collectively, may cause the electronic apparatus to, based on the score being below the second threshold value, acquire the registered voice signal as the reference voice signal.

The instructions, when executed by the at least one processor individually or collectively, may cause the electronic apparatus to: based on the score being below the second threshold value, remove noise included in the input voice signal based on the registered voice signal, and acquire the reference voice signal by concatenating the input voice signal from which the noise has been removed with the registered voice signal.

The instructions, when executed by the at least one processor individually or collectively, may cause the electronic apparatus to identify the registered voice signal from among a plurality of registered voice signals based on a similarity between the plurality of registered voice signals and the input voice signal.

The instructions, when executed by the at least one processor individually or collectively, may cause the electronic apparatus to: acquire a plurality of scores representing a quality of each of the plurality of registered voice signals, and acquire a plurality of registered texts corresponding to each of the plurality of registered voice signals, and identify the registered voice signal from among the plurality of registered voice signals based on the similarity, the plurality of scores representing the quality of each of the plurality of registered voice signals, and types of the plurality of registered texts.

The instructions, when executed by the at least one processor individually or collectively, may cause the electronic apparatus to, based on the registered voice signal not being identified, acquire the input voice signal as the reference voice signal.

Registration information including the plurality of registered voice signals and the plurality of scores may be stored in the memory, and the instructions, when executed by the at least one processor individually or collectively, may cause the electronic apparatus to update the registration information by adding the reference voice signal to the plurality of registered voice signals and adding the score indicating the level of quality of the input voice signal to the plurality of scores.

The instructions, when executed by the at least one processor individually or collectively, may cause the electronic apparatus to: acquire text in a first language corresponding to the input voice signal, and the input text may be acquired by translating the text into a second language.

According to an aspect of the disclosure, method for controlling an electronic apparatus, the method including: based on an input voice signal corresponding to an utterance of a user being received, acquiring quality information including a score indicating a level of quality of the input voice signal; based on the score being below a first threshold value, identifying a registered voice signal among a plurality of registered voice signals for the user in a memory; based on the registered voice signal being identified, acquire a reference voice signal representing voice features of the user based on the registered voice signal; and acquiring an output voice signal for the input voice signal based on input text corresponding to the input voice signal and the reference voice signal.

The acquiring the quality information may include acquiring the quality information based on at least one of a length of the input voice signal, a length of a voice portion included in the input voice signal, a length of a noise portion included in the input voice signal, or a frequency variation of the input voice signal.

The method may further include, based on the score being greater than or equal to the first threshold value, acquiring the input voice signal as the reference voice signal.

The acquiring the reference voice signal may include, based on the score being below the first threshold value and greater than or equal to a second threshold value that is less than the first threshold value, acquiring the reference voice signal by concatenating the input voice signal and the registered voice signal.

The method may further include, based on the score being below the second threshold value, acquiring the registered voice signal as the reference voice signal.

The method may further include: based on the score being below the second threshold value, removing noise included in the input voice signal based on the registered voice signal, and acquiring the reference voice signal by concatenating the input voice signal from which the noise has been removed with the registered voice signal.

The identifying the registered voice signal among the plurality of registered voice signals may be based on a similarity between the plurality of registered voice signals and the input voice signal.

The score may be based on at least one of a length of the input voice signal being greater than or equal to an input voice threshold length value, a length of a voice portion included in the input voice signal being greater than or equal to a voice threshold length value, a length of a noise portion included in the input voice signal being greater than or equal to a noise threshold length value, or a frequency variation of the input voice signal being greater than or equal to a frequency variation threshold level.

According to an aspect of the disclosure, a non-transitory computer-readable recording medium stores instructions that, when executed by at least one process of an electronic apparatus, may cause the electronic apparatus to perform a method including: based on an input voice signal corresponding to an utterance of a user being received, acquiring quality information including a score indicating a level of quality of the input voice signal; based on the score being below a first threshold value, identifying a registered voice signal among a plurality of registered voice signals for the user stored in memory; based on the registered voice signal being identified, acquire a reference voice signal representing voice features of the user based on the registered voice signal; and acquiring an output voice signal for the input voice signal based on input text corresponding to the input voice signal and the reference voice signal.

### BRIEF DESCRIPTION OF THE DRAWINGS

The above and other aspects, features, and advantages of certain embodiments according to the present disclosure will be more apparent from the following description taken in conjunction with the accompanying drawings, in which:

FIG. 1 is a block diagram illustrating an exemplary configuration of an electronic apparatus according to one or more embodiments of the present disclosure;

FIG. 2 is a diagram illustrating an operation performed by a plurality of modules according to one or more embodiments of the present disclosure;

FIG. 3 is a diagram illustrating an operation when a score is greater than or equal to a first threshold value and a registered voice signal corresponding to an input voice signal is not identified according to one or more embodiments of the disclosure;

FIG. 4 is a diagram illustrating an operation for removing noise from an input voice signal according to one or more embodiments of the disclosure;

FIG. 5 is a diagram illustrating an operation for acquiring input text according to one or more embodiments of the disclosure;

FIG. 6 is a diagram illustrating an operation for updating a registration information database according to one or more embodiments of the disclosure;

FIG. 7 is a block diagram illustrating an exemplary configuration of the electronic apparatus according to one or more embodiments of the present disclosure; and

FIG. 8 is a flowchart illustrating a controlling method of an electronic apparatus according to one or more embodiments of the present disclosure.

### DETAILED DESCRIPTION

Since the present embodiments may be variously modified and have several embodiments, specific embodiments of the present disclosure will be illustrated in the drawings and be described in detail in the detailed description. However, it is to be understood that the disclosure are not limited to specific embodiments, but include all modifications, equivalents, and substitutions according to exemplary embodiments of the disclosure. Throughout the accompanying drawings, similar components will be denoted by similar reference numerals.

In describing the disclosure, when it is decided that a detailed description for the known functions or configurations related to the disclosure may unnecessarily obscure the gist of the disclosure, the detailed description therefor will be omitted.

In addition, the following embodiments may be modified in several different forms, and the scope and spirit of the disclosure are not limited to the following embodiments. Rather, these embodiments make the disclosure thorough and complete, and are provided to completely transfer the spirit of the disclosure to those skilled in the art.

Terms used in the disclosure are used only to describe specific embodiments rather than limiting the scope of the disclosure. Singular expressions are intended to include plural expressions unless the context clearly represents otherwise.

In the present disclosure, an expression "have," "may have," "include," "may include," or the like, indicates existence of a corresponding feature (for example, a numerical value, a function, an operation, a component such as a part, or the like), and does not exclude existence of an additional feature.

In the present disclosure, an expression "A or B," "at least one of A and/or B," "one or more of A and/or B," or the like, may include all possible combinations of items enumerated together. For example, "A or B", "at least one of A and B", or "at least one of A or B" may indicate all of 1) a case in which A is included, 2) a case in which B is included, or 3) a case in which both of A and B are included.

As used herein, the terms "1st" or "first" and "2nd" or "second" may use corresponding components regardless of importance or order and are used to distinguish one component from another without limiting the components.

When it is mentioned that any component (for example: a first component) is (operatively or communicatively) coupled with/to or is connected to another component (for example: a second component), it is to be understood that any component is directly coupled to another component or may be coupled to another component through the other component (for example: a third component).

On the other hand, when it is mentioned that any component (for example, a first component) is "directly coupled" or "directly connected" to another component (for example, a second component), it is to be understood that the other component (for example, a third component) is not present between any component and another component.

An expression "configured (or set) to" used in the disclosure may be replaced by an expression "suitable for," "having the capacity to," "designed to," "adapted to," "made to, or "capable of' depending on a situation. A term "~configured (or set) to" may not necessarily mean "specifically designed to" in hardware.

Instead, an expression "~a device configured to" may mean that the device "is capable of' along with other devices or components. For example, a "processor configured (or set) to perform A, B, and C" may mean a dedicated processor (for example, an embedded processor) for performing the corresponding operations or a generic-purpose processor (for example, a central processing unit (CPU) or an application processor) that may perform the corresponding operations by executing one or more software programs stored in a memory device.

In an embodiment, a "module" or a "unit" may perform at least one function or operation, and be implemented by hardware or software or be implemented by a combination of hardware and software. In addition, a plurality of "modules" or a plurality of "~ers/ors" may be integrated in at least one module and be implemented by at least one processor except for a 'module' or an '~er/or' that needs to be implemented by specific hardware.

Various elements and regions in the drawings are schematically illustrated. Therefore, the spirit of the disclosure is not limited by relatively sizes or intervals illustrated in the accompanying drawings.

Hereinafter, embodiments of the disclosure will be described in detail with reference to the accompanying drawings so that those skilled in the art to which the disclosure pertains may easily practice the disclosure.

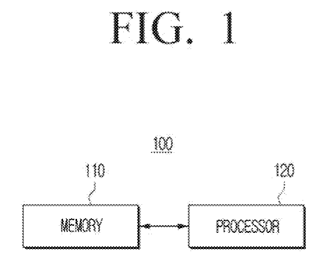

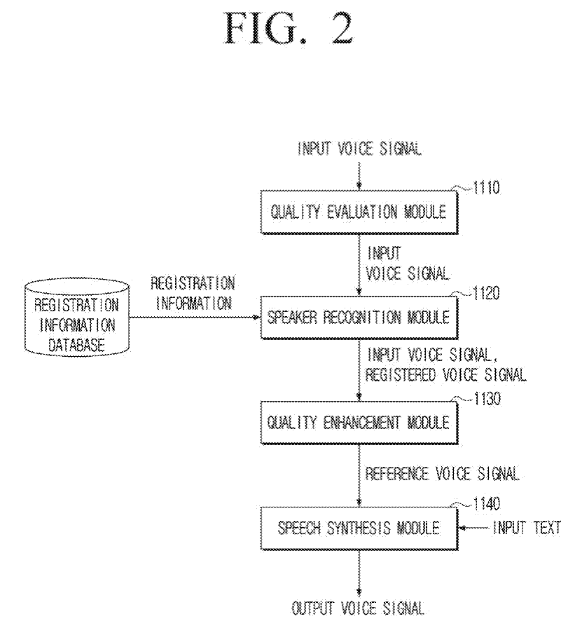

FIG. 1 is a block diagram illustrating a configuration of an electronic apparatus 100 according to one or more embodiments of the present disclosure, and FIG. 2 is a diagram illustrating a plurality of modules and input/output according to one or more embodiments of the present disclosure.

The term 'electronic apparatus 100' may refer to a device capable of enhancing a reference voice signal used for synthesizing a user's voice. For example, the electronic apparatus 100 may be implemented as a user terminal, such as a smartphone or a tablet PC, or may be implemented as a server, a cloud computing device, or the like. There are no particular limitations on the type of the electronic apparatus 100 according to the present disclosure.

As illustrated in FIG. 1, the electronic apparatus 100 may include memory 110, and a processor 120.

The memory 110 may store at least one instruction regarding the electronic apparatus 100. The memory 110 may store an operating system (O/S) for driving the electronic apparatus 100. In addition, the memory 110 may store various software programs or applications for operating the electronic apparatus 100 according to various embodiments of the present disclosure. The memory 110 may include a semiconductor memory such as a flash memory, or a magnetic storage medium such as a hard disk, or the like.

Specifically, various software modules for operating the electronic apparatus 100 according to various embodiments of the present disclosure may be stored in the memory 110, and the processor 120 may execute various software modules stored in the memory 110 to control the operation of the electronic apparatus 100. That is, the memory 110 is accessed by the processor 120, and readout/recording/correction/deletion/update, and the like, of data may be performed by the processor 120.

The term 'memory 110' in the present disclosure may be used to include the memory 110, a ROM or RAM within the processor 120, or a memory card (e.g., a micro SD card or memory stick) mounted on the electronic apparatus 100.

In an embodiment, the memory 110 may store input voice signals, registered voice signals, reference voice signals, and output voice signals according to the present disclosure. The memory 110 may store registration information, and information on input text, registered text, scores, and threshold values. The memory 110 may also store information on a plurality of modules according to the present disclosure and information on a neural network model.

In addition, various pieces of information necessary within the scope for achieving the object of the present disclosure may be stored in the memory 110, and the information stored in the memory 110 may be updated as received from an external device or input by a user.

The processor 120 controls a general operation of the electronic apparatus 100. Specifically, the processor 120 is connected to the configuration of the electronic apparatus 100, which includes the memory 110, and may control the overall operation of the electronic apparatus 100 by executing at least one instruction stored in the memory 110 as described above.

The processor 120 may be implemented in various schemes. For example, the processor 120 may be implemented by at least one of an application specific integrated circuit (ASIC), an embedded processor, a microprocessor, a hardware control logic, a hardware finite state machine (FSM), or a digital signal processor (DSP). In the present disclosure, the term 'processor 120' may be used as meaning including a central processing unit (CPU), a graphic processing unit (GPU), a main processor unit (MPU), and the like.

In an embodiment, the processor 120 may enhance the reference voice signal representing the user's voice features. Specifically, the processor 120 may enhance the reference voice signal used for speech synthesis using a voice signal input according to the user's utterance and a pre-stored registered voice signal.

The user's 'voice features' may collectively refer to the unique features of the user's voice, including, for example, timbre, intonation, pronunciation, prosody, and style. 'Enhancing the reference voice signal' may refer to acquiring a high-quality voice signal that effectively represents the user's voice features. The term 'enhancement' may also be replaced with terms such as 'improvement' or 'augmentation.'

The processor 120 may enhance the reference voice signal using a plurality of modules. As illustrated in FIG. 2, the plurality of modules according to an embodiment may include a quality evaluation module 1110, a speaker recognition module 1120, a quality enhancement module 1130, and a speech synthesis module 1140.

For convenience of explanation, the following description assumes that all of the plurality of modules are implemented by the processor 120 of the electronic apparatus 100. However, various embodiments according to the present disclosure may also be applied even when at least one of the plurality of modules is implemented by an external device. Hereinafter, various embodiments implemented by the processor 120 using the plurality of modules will be described with reference to FIG. 2 along with FIG. 1.

When the input voice signal according to the user's utterance is received, the processor 120 may acquire quality information including a score indicating a level of quality of the input voice signal. The 'input voice signal' may refer to a voice signal generated according to the user's utterance and input to the electronic apparatus 100. Specifically, the processor 120 may receive an input voice signal according to the user's utterance through a microphone included in the electronic apparatus 100. The processor 120 may also receive the input voice signal from an external device through a communication interface 130 included in the electronic apparatus 100.

As illustrated in FIG. 2, the processor 120 may input the input voice signal to the quality evaluation module 1110 and perform a quality evaluation process of the input voice signal. The quality evaluation module 1110 may evaluate the quality of the input voice signal. Specifically, when the input voice signal is input, the quality evaluation module 1110 may acquire quality information. The 'quality information' may refer to a level (or degree) of quality of the input voice signal. The quality information may include a score indicating the level of quality of the input voice signal. Additionally, the quality evaluation module 1110 may identify whether the acquired score is greater than or equal to a preset first threshold value and acquire the identification result.

For convenience of explanation, the following description will exemplify the score included in the quality information as an indicator of quality evaluation. However, the present disclosure is not limited thereto. For example, any information that may indicate the quality of the input voice signal, such as a 'priority' or a 'quality level', may be used in place of the score.

The quality evaluation module 1110 may acquire quality information based on at least one of a length of the input voice signal, a length of the voice portion included in the input voice signal, a length of a noise portion included in the input voice signal, or a frequency variation of the voice signal.

In an embodiment, the quality evaluation module 1110 may acquire the score based on the length of the input voice signal (e.g., the duration of the input voice signal). For example, when the length of the input voice signal is greater than or equal to the threshold value (e.g., an input voice threshold length value), the quality evaluation module 1110 may acquire a higher score compared to cases where the length of the input voice signal is less than the threshold value.

In an embodiment, the quality evaluation module 1110 may acquire the score based on a length of a voice portion (e.g., the duration of the voice portion) included in the input voice signal. For example, when the length of the voice portion included in the input voice signal is greater than or equal to a threshold length (e.g., a voice threshold length value), the quality evaluation module 1110 may acquire a higher score compared to cases where the length of the voice portion included in the input voice signal is below the threshold value.

In an embodiment, the quality evaluation module 1110 may acquire the score based on the length of the noise portion (e.g., the duration of the noise portion) included in the input voice signal. For example, when the length of the noise portion included in the input voice signal is greater than or equal to the threshold length (e.g., a noise threshold length value), the quality evaluation module 1110 may acquire a higher score compared to cases where the length of the noise portion included in the input voice signal is below the threshold value.

For example, the process of distinguishing between the voice and noise portions in the input voice signal may be performed through a voice activity detection (VAD) process. Specifically, the quality evaluation module 1110 may extract features for each segment based on the energy, frequency characteristics, and signal-to-noise ratio (SNR) of the input voice signal and identify whether the extracted features exceed a specific criterion (e.g., a threshold value) to distinguish between the voice and noise portions in the input voice signal.

Acquiring the score according to the embodiments described above may make it difficult to accurately represent the user's voice features when the length of the input voice signal is too short (e.g., when the length of the input voice signal is brief), when the length of the voice portion included in the input voice signal is too short (e.g., when the duration of the voice portion is brief), or when the length of the noise portion included in the input voice signal is too long (e.g., when the duration of the noise portion is too long), and thus, is based on the consideration that it may be difficult to obtain an output voice signal reflecting the user's voice features.

In an embodiment, the quality evaluation module 1110 may acquire the score based on the frequency variation of the voice signal. For example, when the frequency variation of the voice signal is below the threshold level (e.g., a frequency variation threshold level), the quality evaluation module 1110 may acquire a higher score than when the frequency variation of the voice signal is greater than or equal to the threshold level. In particular, when the frequency variation of the voice signal is greater than or equal to the threshold level, such as when the pitch, which indicates the high and low of the sound according to the voice signal, changes rapidly or trembles, the quality evaluation module 1110 may evaluate the quality of the input voice signal as low.

The quality evaluation module 1110 may acquire the score based on a combination of two or more of the length of the voice portion included in the input voice signal, the length of the noise portion included in the input voice signal, and the frequency variation of the voice signal.

In an embodiment, the quality evaluation module 1110 may identify whether the length of the input voice signal is greater than or equal to the threshold length, whether the length of the voice portion included in the input voice signal is greater than or equal to a threshold length, whether the length of the noise portion included in the input voice signal is greater than or equal to the threshold length, and whether the frequency variation of the voice signal is less than the threshold level, and assign a higher score as the number of conditions in which the input voice signal corresponds to the above four conditions increases. For example, the quality evaluation module 1110 may assign a score of 4 when the input voice signal corresponds to all four conditions, and a score of 1 when the input voice signal corresponds to only one of the above four conditions.

In an embodiment, the quality evaluation module 1110 may assign a score to at least one of the length of the input voice signal, the length of the voice portion included in the input voice signal, the length of the noise portion included in the input voice signal, or the frequency variation of the voice signal, and may acquire a final score based on a weighted sum of each score. The weights for each score used in the weighted sum may be changed according to user or developer settings. For example, the highest weight may be assigned to the length of the voice portion included in the input voice signal, and the lowest weight may be assigned to the frequency variation of the voice signal.

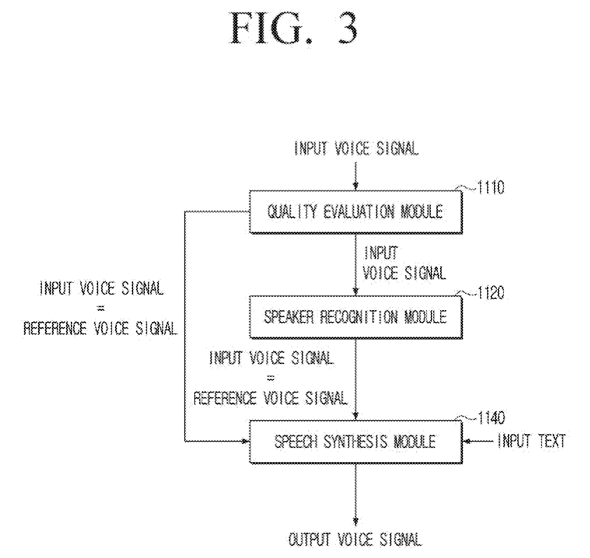

When the score is below a preset first threshold value, the processor 120 may identify a registered voice signal for a user in the memory 110. A 'first threshold value' may refer to a value that serves as a reference for determining whether to perform a quality enhancement process on the input voice signal, and may be changed according to the user or developer settings. That is, when the score indicating the quality of the input voice signal is equal to or greater than the first threshold value, the quality enhancement process for the input voice signal may not be necessary, whereas when the score indicating the quality of the input voice signal is less than the first threshold value, the quality enhancement process for the input voice signal may be necessary. An embodiment related to the case where the score is equal to or greater than the first threshold value will be described in detail with reference to FIG. 3.

The term 'registered voice signal' may refer to a voice signal registered as a voice signal for a specific user. Specifically, the term 'registered voice signal' may be used to refer to a voice signal that has been identified as a voice signal according to a specific user's utterance and whose associated information is stored in the memory 110.

The information (hereinafter referred to as "registration information") on the registered voice signal may be stored in the memory 110 of the electronic apparatus 100 or in the memory 110 of the external device. The registration information may include a file corresponding to the registered voice signal, and the file may be stored in various formats, such as waveform audio file format (WAV) or free lossless audio codec (FLAC).

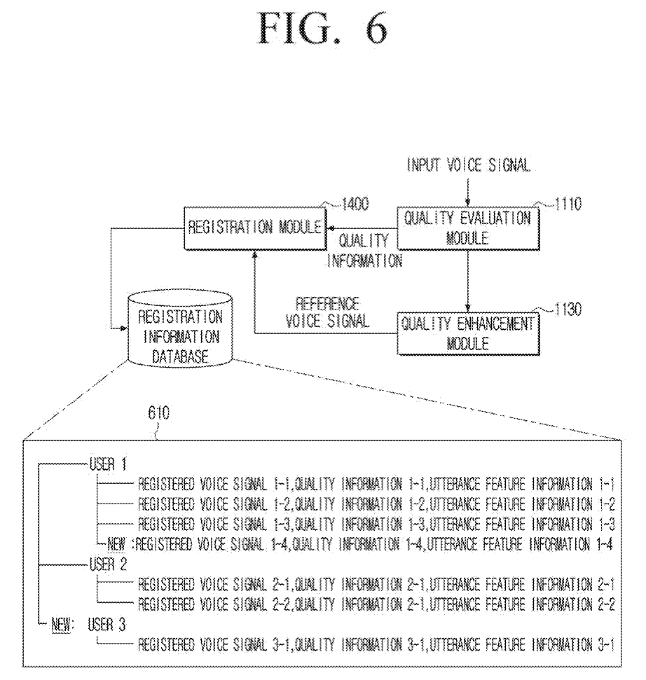

Furthermore, the registration information may include a score indicating the quality of the registered voice signal, utterance feature information on the registered voice signal, and registration text corresponding to the registered voice signal. The registration information may be implemented as a registration information database, as illustrated in FIG. 2, and the registration information database may be stored in the memory 110 of the electronic apparatus 100 or in the memory of the external device. An embodiment related to the operation of updating the registration information database will be described in detail with reference to FIG. 6.

When the registration information includes the utterance feature information for the registered voice signal, the processor 120 may input the registered voice signal to an utterance feature information module (which may be included in the speaker recognition module 1120 as described below) to acquire the utterance feature information corresponding to the registered voice signal, and store the acquired utterance feature information along with the registered voice signal in the memory 110 as the registration information. In addition, when there is the plurality of registered voice signals for a specific user, the processor 120 may calculate an average of the plurality of utterance feature information corresponding to each of the plurality of registered voice signals, and store the average of the plurality of utterance feature information in the memory 110 as the registration information.

When the registration information includes registration text corresponding to the registered voice signal, the processor 120 may perform speech recognition on the registered voice signal to acquire registration text corresponding to the registered voice signal, and store the acquired registration text along with the registered voice signal in the memory 110 as the registration information.

As illustrated in FIG. 2, when the score is below the first threshold value, the processor 120 inputs the input voice signal to the speaker recognition module 1120 to identify the registered voice signal for the user. The speaker recognition module 1120 may recognize a user who has uttered a voice corresponding to the input voice signal, i.e., a speaker. The speaker recognition module 1120 may identify a user corresponding to the input voice signal, and specifically, may identify the registered voice signal corresponding to the input voice signal by comparing the registered voice signal stored in the memory 110 with the input voice signal.

The identification process for a single registered voice signal stored in the registration information database is identical to that for the plurality of registered voice signals. Therefore, the following description assumes a case where the plurality of registered voice signals is stored. An embodiment of the case where the registered voice signal corresponding to the input voice signal may not be identified is described in detail with reference to FIG. 3.

The speaker recognition module 1120 may identify the registered voice signal for the user (i.e., the user who has uttered the voice corresponding to the input voice signal) based on the similarity (or distance) between the plurality of registered voice signals stored in the registration information database and the input voice signal.

The speaker recognition module 1120 may include a neural network (which may be referred to as an utterance feature extraction module, encoder, embedder, etc.) trained to acquire utterance feature information representing the input voice signal features. For example, the speaker recognition module 1120 may include, for example, a time-delay neural network (TDNN) model, which primarily features training time delay patterns, or an emphasized channel attention, propagation, and aggregation time-delay neural network (ECAPA-TDNN) model, which is based on TDNN but additionally applies channel emphasis, attention mechanism, etc. However, there are no particular restrictions on a type of neural network used to implement the speaker recognition module 1120.

The 'utterance feature information' may include information representing the user-specific features extracted from the voice uttered by the user. The utterance feature information may be replaced with terms such as 'feature value,' 'feature vector,' and 'embedding.' The utterance feature information may be acquired after the input voice signal is acquired, but may also be acquired in advance and stored as the registration information in the memory 110 before the input voice signal is acquired.

The speaker recognition module 1120 may acquire the utterance feature information for each of the plurality of registered voice signals and the input voice signal. The speaker recognition module 1120 may calculate a value indicating the similarity (e.g., cosine similarity, Jaccard similarity, Euclidean distance, etc.) between the utterance feature information corresponding to each of the plurality of registered voice signals and the utterance feature information corresponding to the input voice signal, thereby identifying the registered voice signal corresponding to the input voice signal among the plurality of registered voice signals.

The plurality of registered voice signals may be registered voice signals for a single user, or registered voice signals for multiple users. When the plurality of registered voice signals are registered voice signals for multiple users, the speaker recognition module 1120 may identify the user corresponding to the input voice signal among the plurality of users. Furthermore, when the user corresponding to the input voice signal is identified, the speaker recognition module 1120 may identify the registered voice signal corresponding to the input voice signal among the plurality of registered voice signals for the identified user.

For example, the speaker recognition module 1120 may calculate an average of the utterance feature information corresponding to the registered voice signals for each of the multiple users. By identifying the average of the utterance feature information for each of the multiple users with the highest similarity to the utterance feature information of the input voice signal, the user corresponding to the input voice signal may be identified among the multiple users. Furthermore, by identifying the utterance feature information with the highest similarity to the utterance feature information of the input voice signal among the plurality of registered voice signals for the identified user, the registered voice signal corresponding to the input voice signal may be identified among the plurality of registered voice signals for the identified user.

When the user corresponding to the input voice signal is identified, the processor 120 may use the average of the utterance feature information of the identified user to acquire the output voice signal. In addition, the processor 120 may also use only the utterance feature information of the registered voice signal corresponding to the input voice signal among the plurality of voice signals for the identified user to acquire the output voice signal. When the average of the utterance feature information of the identified user is used to acquire the output voice signal, the representative voice feature of the user may be stably implemented, whereas, when the utterance feature information of only a specific voice signal among the plurality of voice signals for the identified user is used to acquire the output voice signal, the voice features of the user that best matches the prosody, style, etc., of the input voice signal may be implemented.

The above-described embodiment identifies the registered voice signal for the user based on the similarity between the plurality of registered voice signals and the input voice signal. However, the speaker recognition module 1120 may concatenate the similarity, the plurality of scores corresponding to each of the plurality of registered voice signals, and at least one of the plurality of registered texts corresponding to each of the plurality of registered voice signals, thereby identifying the registered voice signal for the user.

In an embodiment, the speaker recognition module 1120 may acquire the plurality of scores indicating the quality of each of the plurality of registered voice signals. The speaker recognition module 1120 may acquire the plurality of registered texts corresponding to each of the plurality of registered voice signals. Furthermore, the speaker recognition module 1120 may identify the registered voice signal using not only the similarity but also at least one of the plurality of scores and the types of the plurality of registered texts.

For example, the speaker recognition module 1120 may identify the registered voice signal by assigning a high weight to the registered voice signal with a high score among the plurality of registered voice signals. That is, the speaker recognition module 1120 may preferentially identify the registered voice signals with relatively high quality and reduce the frequency of identifying the registered voice signals with relatively low quality. This is because it is difficult to expect a high quality improvement effect when performing the quality improvement process described below using the registered voice signals with low quality.

For example, when the input text is an interrogative sentence, the speaker recognition module 1120 may assign a high weight to the registered voice signal corresponding to the interrogative sentence among the plurality of registered voice signals based on the plurality of registered texts. When the input text is a conversational text, the speaker recognition module 1120 may identify the registered voice signal by assigning the high weight to the registered voice signal corresponding to the conversational text among the plurality of registered voice signals based on the plurality of registered texts. This is to identify the registered voice signal that best matches the prosody and style of the input voice signal and utilize the registered voice signal in the quality improvement process.

In addition, the speaker recognition operations may be implemented in various ways depending on the design or configuration of the speech synthesis module 1140. For example, depending on which of the registered voice signals among factors such as sound quality, speaker similarity, delay prevention, and the like, the speech synthesis module 1140 may determine which of the registered voice signals to assign a higher weight.

When the registered voice signal is identified, the processor 120 may acquire the reference voice signal by improving the quality of the input voice signal based on the registered voice signal. The 'reference voice signal' may refer to the voice signal representing the user's voice features. The reference voice signal may be acquired based on the input voice signal and the registered voice signal and may be used to synthesize the output voice signal.

As illustrated in FIG. 2, the processor 120 may input the input voice signal and the registered voice signal to the quality enhancement module 1130 to acquire the reference voice signal. The 'quality enhancement module 1130' may refer to a module capable of improving the quality of the voice signal. Specifically, when the input voice signal and the registered voice signal are input, the quality enhancement module 1130 may improve the quality of the input voice signal based on the registered voice signal.

Hereinafter, the quality enhancement will be expressed as improving the quality of the input voice signal. However, this is for convenience of description only. The processor 120 may acquire the reference voice signal by improving the quality of the registered voice signal, or acquire the reference voice signal using both the input voice signal and the registered voice. In other words, the quality enhancement module 1130 may implement various embodiments as described below to acquire the reference voice signal with a quality superior to that of the input voice signal or the registered voice signal, respectively, by using at least one of the input voice signals and the registered voice signals.

In an embodiment, when the score is below a first threshold value and greater than a second threshold value that is less than the first threshold value, the quality enhancement module 1130 may concatenate the input voice signal and the registered voice signal to acquire the reference voice signal. On the other hand, when the score is below the second threshold value, the quality enhancement module 1130 may acquire the registered voice signal as the reference voice signal.

The 'second threshold value' is a value that serves as a reference for determining whether to use the input voice signal for quality enhancement, and may refer to a value less than the first threshold value and may be changed based on user or developer settings. In other words, when the score indicating the quality of the input voice signal is greater than or equal to the second threshold value, it may be preferable to use the input voice signal for quality enhancement, whereas, when the score indicating the quality of the input voice signal is below the second threshold value, it may not be preferable to use the input voice signal for quality enhancement.

For example, when the score indicating the quality of the input voice signal is below a first threshold value and thus requires the quality enhancement process, but the quality of the input voice signal is higher than a second threshold value and thus it is preferable to use the input voice signal for the quality enhancement process, the quality enhancement module 1130 may acquire the reference voice signal using the input voice signal along with the registered voice signal. On the other hand, when the score indicating the quality of the input voice signal is below the first threshold value and thus requires the quality enhancement process, but the quality of the input voice signal is less than the second threshold value and thus it is not preferable to use the input voice signal for the quality enhancement process, the quality enhancement module 1130 may acquire the registered voice signal as the reference voice signal, excluding the input voice signal.

The process of concatenating the input voice signal and the registered voice signal may be performed as follows. For example, the quality enhancement module 1130 may concatenate two signals so that the two signals are continuous. In particular, when the time at which the registered voice signal is acquired is within a critical period from the time at which the input voice signal is input, the timbre and style of the input voice signal are likely to correspond to those of the registered voice signal. Therefore, simply concatenating input voice signals and registered voice signals with similar timbre and style and increasing the length of the reference voice signal may result in improved quality.

In addition, the quality enhancement module 1130 may further perform normalization to adjust the magnitude of the two signals to a certain level, smoothing to alleviate sudden changes (spikes or noise) in the voice signal, and noise suppression to remove unwanted background noise from the voice signal before or after concatenating the input voice signal and the registered voice signal to prevent quality degradation due to discontinuity in the boundary between the two signals. When the quality of the registered voice signal is less than or equal to a certain level or is less than or equal to than the input voice signal, the quality enhancement module 1130 may acquire the input voice signal as the reference voice signal, excluding the registered voice signal from the quality enhancement process.

In an embodiment, when the score is below the second threshold value, the quality enhancement module 1130 may remove noise from the input voice signal and acquire the reference voice signal by concatenating the input voice signal from which the noise has been removed and the registered voice signal.

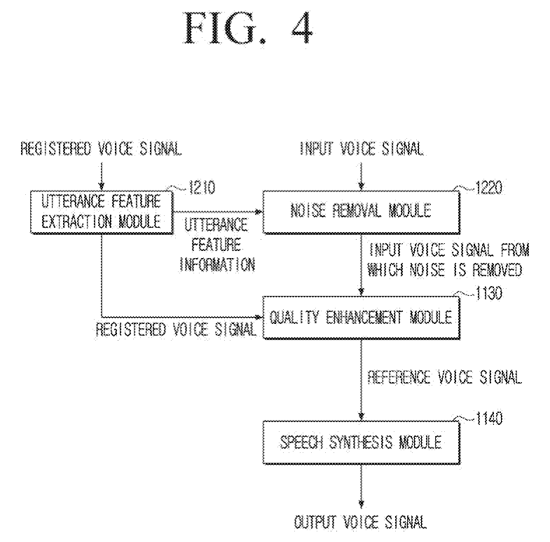

An embodiment of removing noise from the input voice signal based on the registered voice signal is described in detail with reference to FIG. 4.

The quality enhancement methods described above are not independent of each other and may, of course, contribute to further improving the quality of the reference voice signal by being performed sequentially or comprehensively. In addition, in an embodiment, after performing some of the quality enhancement methods described above, when the quality of the reference voice signal is evaluated and then the quality is below a threshold level, other some of the quality enhancement methods described above may be performed again.

The processor 120 may acquire the output voice signal for the input voice signal based on the input text corresponding to the input voice signal and the reference voice signal. The 'output voice signal' refers to the output voice signal that includes information on the input voice signal. Specifically, the 'output voice signal' may refer to a voice signal corresponding to the input text and reflecting the user's voice features.

As illustrated in FIG. 2, the processor 120 may input the input text and the reference voice signal to the speech synthesis module 1140 to acquire the output voice signal. Specifically, the processor 120 may acquire utterance feature information corresponding to the reference voice signal, input the utterance feature information and input text into a speech synthesis module 1140, and acquire the output voice signal in which the utterance feature information corresponding to the reference voice signal is reflected.

The 'speech synthesis module 1140' may synthesize the voice signal by converting the input text into speech, and may include a neural network model. For example, the neural network model included in the speech synthesis module 1140 may include a model referred to as a so-called speech synthesis model or a text-to-speech (TTS) model.

The 'input text' may refer to text corresponding to the input voice signal. Specifically, the input text may be text representing a translation result for the input voice signal, or text input along with the input voice signal. For example, the input voice signal may be a voice signal representing speech in a first language (e.g., Korean), and the input text may be text representing the result of translating text acquired as a result of speech recognition for the input voice signal into a second language (e.g., English).

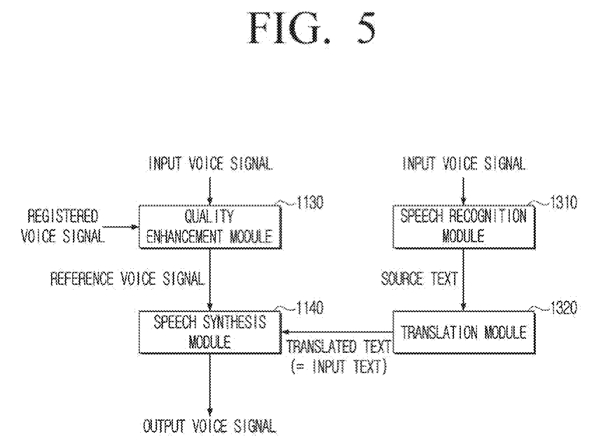

For example, when the input voice signal is a voice signal representing the speech in the first language (e.g., Korean), and the input text is text representing the result of translating the text acquired as a result of speech recognition for the input voice signal into a second language (e.g., English), the output voice signal may be a voice signal representing speech in the second language (e.g., English). Consequently, for the input voice signal representing speech in the first language (e.g., Korean), the output voice signal representing the speech in the second language (e.g., English) may be acquired. An embodiment related to an operation of acquiring input text corresponding to the input voice signal will be described in detail with reference to FIG. 5.

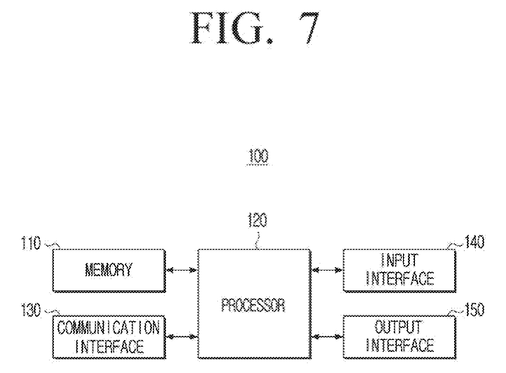

When the output voice signal is acquired, the processor 120 may provide the output voice signal. Furthermore, the processor 120 may provide text corresponding to the output voice signal along with the output voice signal. An embodiment related to providing the output voice signal will be described in detail with reference to FIG. 7.

According to the embodiments described above with reference to FIGS. 1 and 2, the electronic apparatus 100 may enhance the reference voice signal used for the speech synthesis using the voice signal input according to the user's utterance and the pre-stored registered voice signal. Accordingly, the electronic apparatus 100 may acquire the synthesized speech with a remarkably high similarity to the user's actual voice.

FIG. 3 is a diagram illustrating one or more embodiments related to an operation when a score is greater than or equal to a first threshold value and a registered voice signal corresponding to an input voice signal is not identified.

In the above description, with reference to FIGS. 1 and 2, one or more embodiments related to operations when the score is below the first threshold value and operations when the registered voice signal corresponding to the input voice signal is identified have been described.

As illustrated in FIG. 3, the processor 120 may acquire the output voice signal using the input voice signal as the reference voice signal without improving the quality of the input voice signal using the quality enhancement module 1130. In an embodiment, when the score is greater than or equal to the first threshold value or the registered voice signal for the user is not identified, the processor 120 may acquire the input voice signal as the reference voice signal.

As illustrated in FIG. 3, the processor 120 may input the input voice signal to the quality evaluation module 1110 and perform the quality evaluation operation of the input voice signal. When the score acquired through the quality evaluation module 1110 is greater than or equal to the first threshold value, the processor 120 may acquire the input voice signal as the reference voice signal.

That is, when the score is greater than or equal to the first threshold value, it may be the case that the quality enhancement process for the input voice signal is not necessary, and therefore the processor 120 may not perform the quality enhancement process and may treat the input voice signal itself as the reference voice signal. Then, the processor 120 may input the input voice signal as the reference voice signal to the speech synthesis module 1140, and input the input text along with the input voice signal to the speech synthesis module 1140, thereby acquiring the output voice signal.

When the score acquired through the quality evaluation module 1110 is below the first threshold value, as illustrated in FIG. 3, the processor 120 inputs the input voice signal to the speaker recognition module 1120 to identify the registered voice signal for the user.

When the registered voice signal for the user is identified through the speaker recognition module 1120, the processor 120 may acquire the reference voice signal by improving the quality of the input voice signal based on the registered voice signal, as described above.

On the other hand, when the registered voice signal for the user is not identified through the speaker recognition module 1120, as illustrated in FIG. 3, the processor 120 may acquire the input voice signal as the reference voice signal. Then, the processor 120 may input the input voice signal as the reference voice signal to the speech synthesis module 1140, and input the input text along with the input voice signal to the speech synthesis module 1140, thereby acquiring the output voice signal.

According to the embodiments described above with reference to FIG. 3, when the quality enhancement process for the input voice signal is not required, or when the registered voice signal for a user, which is the voice signal for the quality enhancement of the input voice signal, is not identified, the electronic apparatus 100 treats the input voice signal itself as the reference voice signal, thereby efficiently performing the speech synthesis.

FIG. 4 is a diagram for describing one or more embodiments related to removing noise from an input voice signal.

As described above, when the score indicating the quality of the input voice signal is below the first threshold value and thus requires the quality enhancement process, but the quality of the input voice signal is less than the second threshold value and thus it is not preferable to use the input voice signal for the quality enhancement process, the processor 120 may acquire the registered voice signal as the reference voice signal, excluding the input voice signal.

In an embodiment, when the quality of the input voice signal is less than the second threshold value and thus it is not preferable to use the input voice signal in the quality enhancement process, the processor 120 may remove noise from the input voice signal using the registered voice signal without excluding the input voice signal, and then perform the quality enhancement process described above.

Referring to FIG. 4, the processor 120 may input the registered voice signal to the utterance feature extraction module 1210 to acquire the utterance feature information for the registered voice signal.

The 'utterance feature extraction module 1210' may refer to a module capable of extracting the utterance feature information indicating the user's unique features from the input voice signal. The utterance feature extraction module 1210 may include the neural network model trained to extract the user's utterance features from the input voice signal. As described above, the 'utterance feature information' may include information representing the user-specific features extracted from the voice uttered by the user. While the descriptions of FIGS. 1 and 2 described the utterance feature information extracted from the input voice signal, the utterance feature information may also be extracted from the registered voice signal (or the reference voice signal as the voice signal which is the target of registration). The utterance feature information may be replaced with terms such as 'feature value,' 'feature vector,' and 'embedding.'

For example, the utterance feature extraction module 1210 may include a time- delay neural network (TDNN) model, which primarily features training time delay patterns, or an emphasized channel attention, propagation, and aggregation time-delay neural network (ECAPA-TDNN) model, which is based on TDNN but additionally applies channel emphasis, attention mechanism, etc. The utterance feature extraction module 1210 may be implemented as a separate module from other modules as illustrated in FIG. 4, but may also be included in the speaker recognition module 1120 or the noise removal module 1220.

When the utterance feature information for the registered voice signal is acquired, the processor 120 inputs the input voice signal and the utterance feature information for the registered voice signal to the noise removal module 1220, thereby acquiring the input voice signal from which noise has been removed.

The "noise removal module 1220" may refer to a module that removes noise from the input voice signal and retains only the signal corresponding to the user's voice. For example, the noise removal module 1220 may include the neural network model trained to generate mask information to retain only the user's voice from the input voice signal. The noise removal module 1220 may also be referred to as a speech enhancement module, etc.

The 'mask information' may represent information for enhancing components corresponding to the user's voice in the input voice signal and suppressing remaining components corresponding to noise or other users' voices, and may also be referred to as 'filter information', etc.

For example, the mask information may include multiple weights ranging from 0 to 1, each of which may correspond to a plurality of cells in a spectrogram corresponding to the input voice signal. For each of the multiple weights, a higher value indicates a higher likelihood of matching the user's voice. It may indicate that the lower the value is, the higher the likelihood that the value corresponds to noise or another user's voice.

When the mask information is acquired, the processor 120 may apply the mask information to the input voice signal, thereby acquiring the voice signal from which the noise has been removed. Specifically, when the mask information is acquired through the noise removal module 1220, the processor 120 may acquire the input voice signal from which the noise has been removed by multiplying each of the plurality of cells of the spectrogram corresponding to the input voice signal by each of the multiple weights of the mask information corresponding to each of the plurality of cells.

For example, among the plurality of cells of the spectrogram, a cell corresponding to a mask information weight of corresponding to a mask information weight of 0.8 retains 80% of its original value, allowing the user's voice to be reflected relatively strongly. Among the plurality of cells of the spectrogram, a cell corresponding to a mask information weight 0.2 retains 20% of its original value, allowing the user's voice to be reflected relatively weakly.

For example, after the mask information is applied to the input voice signal, the processor 120 may perform an inverse short-time Fourier transform (inverse STFT) to convert the spectrogram into the time domain, thereby acquiring the input voice signal from which the noise has been removed.

When the input voice signal from which the noise has been removed is acquired through the noise removal module 1220, the processor 120 may input the registered voice signal and the input voice signal from which the noise has been removed to the quality enhancement module 1130 to acquire the reference voice signal. For example, the processor 120 may acquire the reference voice signal with improved quality by concatenating the input voice signal from which the noise has been removed and the registered voice signal using various quality enhancement methods as described above.

When the reference voice signal is acquired, as illustrated in FIG. 4, the processor 120 may input the input text and the reference voice signal to the speech synthesis module 1140 to acquire the output voice signal.

According to the embodiments described above with reference to FIG. 4, even when it is not preferable to use the input voice signal for the quality improvement process, the electronic apparatus 100 may acquire the reference voice signal with improved quality by removing noise from the input voice signal using the registered voice signal and then using the input voice signal from which the noise has been removed. Accordingly, even when the quality level of the input voice signal is very low, it is possible to acquire the reference voice signal with significantly improved quality.

FIG. 5 is a diagram for describing one or more embodiments related to acquiring input text.

As described above, the 'input text' may refer to the text corresponding to the input voice signal, and more specifically, may refer to text representing a translation result for the input voice signal.

In an embodiment, the processor 120 may acquire the text in the first language corresponding to the input voice signal. Furthermore, the processor 120 may translate the text into the second language to acquire the input text.

As illustrated in FIG. 5, the processor 120 inputs the input voice signal to a speech recognition module 1310 to acquire the source text corresponding to the input voice signal.

The 'speech recognition module 1310' may refer to a module capable of acquiring the text corresponding to the input voice signal. The speech recognition module 1310 may include a neural network model, which may be referred to as a speech recognition model or an automatic speech recognition model (ASR). For example, the speech recognition module 1310 may include an acoustic model that converts audio signals into phonemes or words, and a language model that identifies words with high probability among candidate words acquired through the acoustic model.

'Source text' may refer to text corresponding to the input voice signal and may be used as a term to distinguish the source text from a translated text, as described below.

As illustrated in FIG. 5, the processor 120 inputs the source text to a translation module 1320 to acquire the translated text corresponding to the source text.

The 'translation module 1320' may refer to a module capable of acquiring the translated text corresponding to the input source text. The translation module 1320 may include a neural network model, such as a so-called neural machine translation (NMT) model. For example, the translation module 1320 may utilize a self-attention mechanism based on a transformer to simultaneously process an entire sentence to acquire the translated text corresponding to the source text.

The 'translated text' may refer to a translated text of the source text. As illustrated in FIG. 5, the translated text may be input text to the speech synthesis module 1140.

When the translated text is acquired, the processor 120 inputs the translated text along with the reference voice signal acquired through the quality enhancement module 1130 to the speech synthesis module 1140, thereby acquiring the output voice signal corresponding to the input voice signal.

For example, the input voice signal may be the voice signal representing the speech in the first language (e.g., Korean), and the source text may be text in the first language (e.g., Korean) acquired as a result of the speech recognition of the input voice signal. The translated text may be the text in the second language (e.g., English) acquired as a result of translating the source text, and the output voice signal may be a voice signal representing the speech in the second language (e.g., English). Consequently, for the input voice signal representing the speech in the first language (e.g., Korean), the output voice signal representing the speech in the second language (e.g., English) may be acquired.

The above describes embodiments in which the input text represents the translation result of the input voice signal. However, the present disclosure is not limited thereto, and the input text may also be text input along with the input voice signal. The text input along with the input voice signal may refer to text input simultaneously with or after the utterance of the speech corresponding to the input voice signal, as text corresponding to that speech.

According to the embodiments described above with reference to FIG. 5, the electronic apparatus 100 may acquire the synthesized speech with significantly higher similarity to the user's actual voice by strengthening the reference voice signal representing the user's individual utterance characteristics during the process of acquiring the output voice signal translated from the input voice signal.

Therefore, various embodiments according to the present disclosure may be particularly useful in real-time translation processes. In cases where the user's utterance continues, such as in real-time translation, the electronic apparatus 100 may continuously strengthen the reference voice signal to further increase the similarity to the user's actual voice, thereby acquiring the synthesized speech.

FIG. 6 is a diagram for describing one or more embodiments related to updating a registration information database.

The 'registration information database' may refer to information on the registered voice signal, i.e., a collection of data about the registration information. The registration information database may include various types of information on the registered voice signal, along with the registered voice signals for each user. For example, as illustrated in a structural diagram 610 of the registration information database in FIG. 6, the registration information database may include at least one registered voice signals for each user and quality information corresponding to each of the at least one registered voice signals. The registration information database may be stored in the memory 110 of the electronic apparatus 100 or the memory 110 of the external device.

The term 'registered voice signal' may refer to a voice signal registered as a voice signal for a specific user. The term 'registered voice signal' may be used to refer to a voice signal that has been identified as a voice signal according to a specific user's utterance and whose associated information is stored in the memory 110. In particular, the registered voice signal may refer to the registered reference voice signal acquired through the quality enhancement module 1130.

In an embodiment, the processor 120 may register the acquired reference voice signal as the registered voice signal. As illustrated in FIG. 6, when the user who has uttered the voice corresponding to the input voice signal is user 1, reference voice signal 1-1, reference voice signal 1-2, and reference voice signal 1-3 may be included in the registration information database as registered voice signals for the user 1.

In this case, when a new reference voice signal for the user 1 is acquired through the quality enhancement module 1130, the processor 120 may input the new reference voice signal to the registration module 1400. The registration module 1400 may update the registration information database based on the new reference voice signal. Since the new reference voice signal is a previously registered reference voice signal for the user 1, the registration module 1400 may add the new reference voice signal to the registration information database as reference voice signal 1-4 for the user 1.

The reference voice signals for the user 1 and user 2 may be included in the registration information database as the registered voice signals for the user 1 and user 2, whereas a reference voice signal for user 3 may not be registered. In this case, as illustrated in FIG. 6, when a new reference voice signal for the user 3 is acquired, the processor 120 may add the new reference voice signal to the registration information database as reference voice signal 3-1 for the user 3.

In an embodiment, the processor 120 may add quality information to the registration information database along with the reference voice signal. As illustrated in FIG. 6, when the quality information is acquired through the quality evaluation module 1110, the processor 120 may input the quality information along with the reference voice signal to the registration module 1400. The registration module 1400 may match (or pair) the reference voice signal and quality information corresponding to the same input voice signal, thereby adding a pair of the reference voice signal and quality information to the registration information database.

The quality information added to the registration information database may be various pieces of information that may indicate the quality of the input voice signal, such as a score, priority, and quality level. For example, the processor 120 may update the registration information by adding the acquired reference voice signal to the plurality of registered voice signals and adding the score corresponding to the input voice signal to the plurality of scores corresponding to each of the plurality of registered voice signals.

In an embodiment, the processor 120 may add the utterance feature information for the registered voice signal to the registration information database along with the reference voice signal. As illustrated in FIG. 6, the processor 120 may match the utterance feature information for the registered voice signal with the reference voice signal and add the matched utterance feature information to the registration information database. For example, when there are the plurality of registered voice signals for a user (e.g., user 1 and user 2 of FIG. 6), the processor 120 may calculate an average of the plurality of pieces of utterance feature information corresponding to each of the plurality of registered voice signals and add the average of the utterance feature information to the registration information database.

Although not illustrated in FIG. 6, in an embodiment, the processor 120 may also match the registered text corresponding to the registered voice signal with the reference voice signal and add the registered text to the registration information database.

According to the embodiments described above with reference to FIG. 6, the electronic apparatus 100 may not only synthesize the user's voice using the enhanced reference voice signal according to the present disclosure, but may also use the reference voice signal to enhance the subsequently acquired input voice signals by registering the reference voice signal.

In particular, when the initial input voice signal of the user not registered in the registration information database (e.g., user 3 of FIG. 6) is input, the quality of the output voice signal for the initial input voice signal may not be improved. However, since the initial input voice signal is used as the reference voice signal for the speech synthesis and then the reference voice signal is added to the registration information database, the output voice signal with improved quality may be provided for the subsequent input voice signals based on the user's utterance.

Furthermore, the electronic apparatus 100 may manage the registration information database by matching the quality information and registered text with the reference voice signal, thereby performing the operation of identifying the registered voice signal for the user described with reference to FIGS. 1 and 2 more effectively and efficiently.

Furthermore, when the utterance feature information corresponding to the reference voice signal is extracted in advance and stored in the registration information database, the electronic apparatus 100 may more effectively and efficiently perform the process of acquiring the output voice signal by reflecting the utterance feature information.

FIG. 7 is a block diagram illustrating in detail a configuration of the electronic apparatus 100 according to one or more embodiments of the present disclosure.

As illustrated in FIG. 7, the electronic apparatus 100 according to an embodiment of the present disclosure may further include the communication interface 130, an input interface 140, and an output interface 150, in addition to the memory 110 and the processor 120. However, the configurations illustrated in FIGS. 1 and 7 are merely exemplary, and it is to be understood that new configurations may be added or some configurations may be omitted in addition to the configurations illustrated in FIGS. 1 and 7 when implementing the present disclosure.

The communication interface 130 includes a circuit and may communicate with an external device. Specifically, the processor 120 may receive various data or information from an external device connected through the communication interface 130, and may transmit various data or information to the external device.

The communication interface 130 may include at least one of a WiFi module, a Bluetooth module, a wireless communication module, an NFC module, or an ultra-wide band (UWB) module. Specifically, the WiFi module and the Bluetooth module may communicate via WiFi or Bluetooth, respectively. In the case of using the Wi-Fi module or the Bluetooth module, various types of connection information such as an SSID may first be transmitted and received, and after establishing the communication connection by using the connection information, various types of information may be transmitted and received.

In addition, the wireless communication module may perform communications according to various communication standards, such as IEEE, Zigbee, 3rd generation (3G), 3rd generation partnership project (3GPP), long term evolution (LTE), and 5th generation (5G). The NFC module may perform communications in a near field communication (NFC) manner using a band of 13.56MHz among various RF-ID frequency bands such as 135kHz, 13.56MHz, 433MHz, 860 to 960MHz, and 2.45GHz. In addition, the UWB module may accurately measure a time of arrival (ToA), which is the time it takes for a pulse to reach a target, and an angle of arrival (AoA), which is a pulse arrival angle at a transmitting device, through communication between UWB antennas, thereby enabling precise distance and location recognition within an error range of several tens of centimeters indoors.

In an embodiment, the processor 120 may receive the information on the input voice signal, the registered voice signal, the registration information, etc., from the external device via the communication interface 130. For example, the processor 120 may acquire the input voice signal by receiving the input voice signal acquired from the external device including the microphone via the communication interface 130.

Furthermore, the processor 120 may control the communication interface 130 to transmit the output voice signal and/or text corresponding to the output voice signal (e.g., the translated text) to the external device (e.g., the user terminal such as the smartphone). Accordingly, the user may receive the output voice signal and/or text corresponding to the output voice signal through the speaker and/or display of the external device.

The input interface 140 includes a circuit, and the processor 120 may receive user commands for controlling the operation of the electronic apparatus 100 via the input interface 140. Specifically, the input interface 140 may include components such as a microphone, a camera, and a remote control signal receiving unit. In addition, the input interface 140 is a touch screen, and may be implemented in the form in which it is included in the display. In particular, the microphone may receive a voice signal and convert the received voice signal into an electrical signal.

In an embodiment, the processor 120 may receive the input voice signal according to the user's utterance through the microphone.

The output interface 150 includes a circuit, and the processor 120 may output various functions that the electronic apparatus 100 may perform through the output interface 150. The output interface 150 may include at least one of a display, a speaker, or an indicator.

The display may output video data under the control of the processor 120. Specifically, the display may output videos pre-stored in the memory 110 under the control of the processor 120. In particular, the display according to an embodiment of the present disclosure may display a user interface (UI) stored in the memory 110. The display may be implemented as a liquid crystal display panel (LCD), organic light emitting diodes (OLED), etc., and may also be implemented as a flexible display, a transparent display, etc., depending on the circumstances. However, the display according to the present disclosure is not limited to a specific type.

The speaker may output audio data under the control of the processor 120. The indicator may be turned on under the control of the processor 120. Specifically, the indicator may be illuminated in various colors under the control of the processor 120. For example, the indicator may be implemented in light emitting diodes (LEDs), a liquid crystal display panel (LCD), a vacuum fluorescent display (VFD), etc., but is not limited thereto.

In an embodiment, the processor 120 may control a speaker to output the output voice signal. The processor 120 may also control a display to display text (e.g., the translated text) corresponding to the output voice signal. The processor 120 may also control the speaker and display to display text (e.g., the translated text) corresponding to the output voice signal while the output voice signal is being output. Accordingly, the user may receive the output voice signal and/or text corresponding to the output voice signal through the speaker and/or display of the electronic apparatus 100.

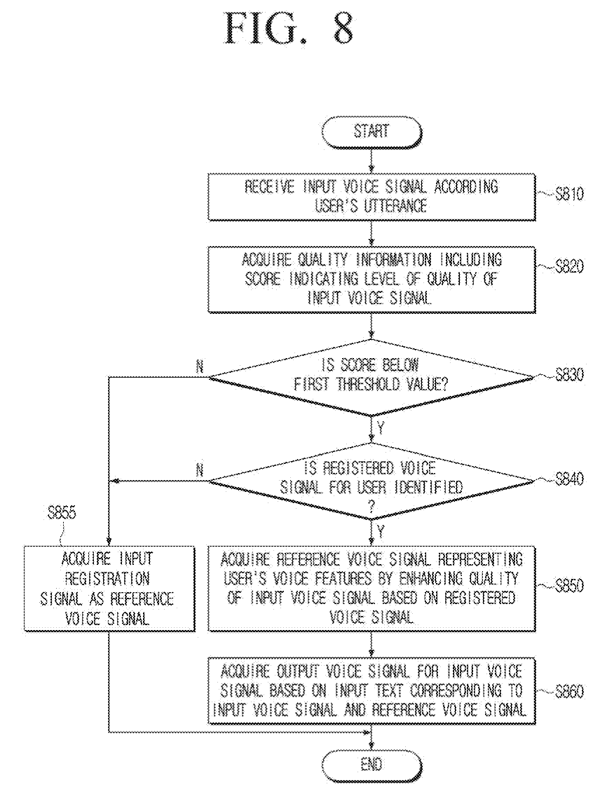

FIG. 8 is a flowchart illustrating a control method of an electronic apparatus 100 according to one or more embodiments of the present disclosure.

The electronic apparatus 100 may receive the input voice signal according to the user's utterance (S810). When the input voice signal according to the user's utterance is received, the electronic apparatus 100 may acquire quality information including a score indicating a level of quality of the input voice signal (S820). For example, the electronic apparatus 100 may receive an input voice signal according to the user's utterance through a microphone included in the electronic apparatus 100. The electronic apparatus 100 may also receive the input voice signal from an external device through the communication interface 130 included in the electronic apparatus 100.

In an embodiment, the electronic apparatus 100 may acquire the quality information based on at least one of the length of the input voice signal, the length of the voice portion included in the input voice signal, the length of the noise portion included in the input voice signal, or the frequency variation of the voice signal.

When the score is below the preset first threshold value (S830-Y), the electronic apparatus 100 may identify the registered voice signal for the user in the memory 110. In an embodiment, the electronic apparatus 100 may identify the registered voice signal for the user (i.e., the user who has uttered the voice corresponding to the input voice signal) based on the similarity between the plurality of registered voice signals stored in the registration information database and the input voice signal.

When the registered voice signal for the user is identified (S840-Y), the electronic apparatus 100 may acquire the reference voice signal by improving the quality of the input voice signal based on the registered voice signal (S850).

In an embodiment, when the score is below a first threshold value and greater than a second threshold value that is less than the first threshold value, the quality enhancement module 1130 may concatenate the input voice signal and the registered voice signal to acquire the reference voice signal. On the other hand, when the score is below the second threshold value, the quality enhancement module 1130 may acquire the registered voice signal as the reference voice signal.

The electronic apparatus 100 may acquire the output voice signal for the input voice signal based on the input text corresponding to the input voice signal and the reference voice signal (S860). When the output voice signal is acquired, the electronic apparatus 100 may provide the output voice signal. Furthermore, the electronic apparatus 100 may provide text corresponding to the output voice signal along with the output voice signal.

When the score is greater than or equal to the preset first threshold value (S830- N), the electronic apparatus 100 may acquire the input registration signal as the reference voice signal and may acquire the output voice signal for the input voice signal based on the input text corresponding to the input voice signal and the reference voice signal.

When the registered voice signal for the user is identified (S840-N), the electronic apparatus 100 may acquire the input registration signal as the reference voice signal and may acquire the output voice signal for the input voice signal based on the input text corresponding to the input voice signal and the reference voice signal.

According to the embodiments described above, the electronic apparatus 100 may enhance the reference voice signal used for the speech synthesis using the voice signal input according to the user's utterance and the pre-stored registered voice signal. Accordingly, the electronic apparatus 100 may acquire the synthesized speech with a remarkably high similarity to the user's actual voice.

Although various embodiments of the present disclosure have been described above on the premise of synthesizing the user's voice using the reference voice signal, the various embodiments described above may also be applied to technologies that use a reference voice for a user, for example, voice conversion (VC) that converts the user's voice into another user's voice.

The control method of an electronic apparatus 100 according to the above- described embodiment may be implemented as a program and provided to the electronic apparatus 100. In particular, a program including the control method of the electronic apparatus 100 may be provided by being stored in a non-transitory computer readable medium.

Specifically, according to an aspect of the present disclosure, there is provided a non-transitory computer-readable recording medium including a program executing the controlling method of an electronic apparatus 100, in which the controlling method of an electronic apparatus 100 may include, when the input voice signal according to the user's utterance is received, acquiring the quality information including the score indicating the level of quality of the input voice signal; when the score is below the preset first threshold value, identifying the registered voice signal for the user in the memory 110; when the registered voice signal is identified, improving the quality of the input voice signal based on the registered voice signal to acquire the reference voice signal representing the user's voice features; and acquiring the output voice signal for the input voice signal based on the input text corresponding to the input voice signal and the reference voice signal.

In the above description, the control method of an electronic apparatus 100 and the computer-readable recording medium including the program for executing the control method of an electronic apparatus 100 have been briefly described, but this is only for omitting redundant description, and of course, various embodiments of the electronic apparatus 100 is also applicable to the computer-readable recording medium including the control method of an electronic apparatus 100 and the program for executing the control method of an electronic apparatus 100.

The artificial intelligence-related functions according to the present disclosure are operated through the processor 120 and memory 110 of the electronic apparatus 100.

The processor 120 may include one or a plurality of processors 120. In this case, the one or more processors 120 may include at least one of a central processing unit (CPU), a graphic processing unit (GPU), or a neural processing unit (NPU), but are not limited to the examples of the processor 120 described above.

The CPU is a general-purpose processor 120 capable of performing not only general operations but also artificial intelligence operations, and may efficiently execute complex programs through a multi-layer cache structure. The CPU is advantageous in a serial processing method that enables organic linking of previous and subsequent calculation results through sequential calculations. Except the case where specifically referred to as the CPU described above, the general-purpose processor 120 is not limited to the examples described above.

The GPU is the processor 120 for large-scale computations, such as floating- point operations used in graphics processing, and integrates a large number of cores to perform large-scale computations in parallel. In particular, the GPU may be advantageous over CPUs for parallel processing methods, such as convolution operations. Furthermore, the GPU may be used as coprocessors 120 to supplement the functions of the CPU. Except the case where specifically referred to as the GPU described above, the processor 120 for large-scale computations is not limited to the examples described above.

The NPU is the processor 120 specialized for artificial intelligence computations using the artificial neural network, and may implement each layer of the artificial neural network in hardware (e.g., silicon). In this case, since the NPU is designed to be specialized according to the specifications required by the manufacturer, the NPU has less flexibility compared to the CPU or GPU, but may efficiently process the artificial intelligence operations required by the manufacturer. The NPU is the processor 120 specialized for the artificial intelligence operations, and may be implemented in various forms, such as a tensor processing unit (TPU), an intelligence processing unit (IPU), and a vision processing unit (VPU). Except where specifically referred to as the NPU described above, the AI processor 120 is not limited to the examples described above.

In addition, the one or more processors 120 may be implemented as a system on chip (SoC). In this case, the SoC may further include the memory 110, and the network interface, such as a bus for the data communication between the processor 120 and the memory 110, in addition to the one or more processors 120.

When the system on chip (SoC) included in the electronic apparatus 100 includes the plurality of processors 120, the electronic apparatus 100 may use some of the processors 120 to perform the AI-related operations (e.g., operations related to AI model learning or inference). For example, the electronic apparatus 100 may use at least one of the GPU, NPU, VPU, TPU, or hardware accelerator specialized for AI operations, such as a convolution operation or a matrix multiplication operation, among the plurality of processors 120. However, this is merely an example, and it is understood that the AI-related operations may be processed using the CPU or other general-purpose processor 120.

In addition, the electronic apparatus 100 may use a plurality of cores (e.g., dual cores, quad cores, etc.) included in the single processor 120 to perform the operations related to the AI-related functions. In particular, the electronic apparatus 100 may perform the artificial intelligence operations such as the convolution operations and the matrix multiplication operations in parallel using the multi-core included in the processor 120.

One or more processors 120 control to process the input data according to the predefined operation rule or the AI model stored in the memory 110. The predefined operation rule or the AI model is characterized by being made through training.

Here, being created through learning means that a predefined motion rule or an artificial intelligence model of a desired characteristic is created by applying a learning algorithm to a plurality of training data. Such learning may be made in the device itself in which the AI according to the present disclosure is performed, or may be made through a separate server/system.

The AI model may include a plurality of neural network layers. At least one layer has at least one weight value, and an operation of the layers is performed based on an operation result of a previous layer and at least one defined operation. Examples of neural networks may include models such as a convolutional neural network (CNN), a deep neural network (DNN), a recurrent neural network (RNN), a restricted Boltzmann machine (RBM), a deep belief network (DBN), a bidirectional recurrent deep neural network (BRDNN), deep Q- networks, and a transformer, and in the present disclosure, unless otherwise specified, the neural networks are not limited to the foregoing examples.

The learning algorithm is a method of training a target device (e.g., a robot) using a plurality of pieces of training data so that the predetermined target device may make decisions or predictions on its own. Examples of the learning algorithms include supervised learning, unsupervised learning, semi-supervised learning, or reinforcement learning, but in the present disclosure, unless otherwise specified, the learning algorithm is not limited to the foregoing examples.

The machine-readable storage medium may be provided in a form of a non- transitory storage medium. Here, the 'non-transitory storage medium' means that the storage medium is a tangible device, and does not include a signal (for example, electromagnetic waves), and the term does not distinguish between the case where data is stored semi- permanently on a storage medium and the case where data is temporarily stored thereon. For example, the 'non-transitory storage medium' may include a buffer in which data is temporarily stored.

According to an embodiment, the methods according to the diverse exemplary embodiments disclosed in the present document may be included and provided in a computer program product. The computer program product may be traded as a product between a seller and a purchaser. The computer program product may be distributed in the form of a machine- readable storage medium (for example, compact disc read only memory (CD-ROM)), or may be distributed (for example, download or upload) through an application store (for example, Play Store^{TM}) or may be directly distributed (for example, download or upload) between two user devices (for example, smart phones) online. In a case of the online distribution, at least some of the computer program products (for example, downloadable app) may be at least temporarily stored in a machine-readable storage medium such as a memory of a server of a manufacturer, a server of an application store, or a relay server or be temporarily generated.

Each of components (for example, modules or programs) according to various embodiments of the present disclosure as described above may include a single entity or a plurality of entities, and some of the corresponding sub-components described above may be omitted or other sub-components may be further included in the diverse embodiments. Alternatively or additionally, some components (e.g., modules or programs) may be integrated into one entity and perform the same or similar functions performed by each corresponding component prior to integration.

Operations performed by the modules, the programs, or the other components according to the diverse embodiments may be executed in a sequential manner, a parallel manner, an iterative manner, or a heuristic manner, at least some of the operations may be performed in a different order or be omitted, or other operations may be added.

Terms "~er/or" or "module" used in the present disclosure may include units configured by hardware, software, or firmware, and may be used compatibly with terms such as, for example, logics, logic blocks, components, circuits, or the like. The "unit" or "module" may be an integrally configured component or a minimum unit performing one or more functions or a part thereof. For example, the module may be configured by an application- specific integrated circuit (ASIC).

Various embodiments of the present disclosure may be implemented by software including instructions stored in a machine-readable storage medium (for example, a computer-readable storage medium). A machine may be a device that invokes the stored instruction from the storage medium and may be operated depending on the invoked instruction, and may include the electronic apparatus (for example, the electronic apparatus 100) according to the disclosed embodiments.

In a case where a command is executed by the processor, the processor may directly perform a function corresponding to the command or other components may perform the function corresponding to the command under a control of the processor. The command may include codes created or executed by a compiler or an interpreter.

Although exemplary embodiments of the present disclosure have been illustrated and described hereinabove, the present disclosure is not limited to the abovementioned specific exemplary embodiments, but may be variously modified by those skilled in the art to which the present disclosure pertains without departing from the gist of the present disclosure as disclosed in the accompanying claims. These modifications should also be understood to fall within the scope and spirit of the present disclosure.

What is claimed is:

1. An electronic apparatus, comprising:
memory storing instructions; and
at least one processor comprising processing circuitry,
wherein the instructions, when executed by the at least one processor individually or collectively, cause the electronic apparatus to:
based on an input voice signal corresponding to an utterance of a user being received, acquire quality information comprising a score indicating a level of quality of the input voice signal,
based on the score being below a first threshold value, identify a registered voice signal for the user stored in the memory,
based on the registered voice signal being identified, acquire a reference voice signal representing voice features of the user based on the registered voice signal, and
acquire an output voice signal for the input voice signal based on input text corresponding to the input voice signal and the reference voice signal.

2. The electronic apparatus as claimed in claim 1, wherein the instructions, when executed by the at least one processor individually or collectively, cause the electronic apparatus to acquire the quality information based on at least one of a length of the input voice signal, a length of a voice portion included in the input voice signal, a length of a noise portion included in the input voice signal, or a frequency variation of the input voice signal.

3. The electronic apparatus of claim 1, wherein the instructions, when executed by the at least one processor individually or collectively, cause the electronic apparatus to, based on the score being greater than or equal to the first threshold value, acquire the input voice signal as the reference voice signal.

4. The electronic apparatus of claim 1, wherein the instructions, when executed by the at least one processor individually or collectively, cause the electronic apparatus to, based on the score being below the first threshold value and greater than or equal to a second threshold value that is less than the first threshold value, acquire the reference voice signal by concatenating the input voice signal and the registered voice signal.

5. The electronic apparatus of claim 4, wherein the instructions, when executed by the at least one processor individually or collectively, cause the electronic apparatus to, based on the score being below the second threshold value, acquire the registered voice signal as the reference voice signal.

6. The electronic apparatus of claim 4, wherein the instructions, when executed by the at least one processor individually or collectively, cause the electronic apparatus to:
based on the score being below the second threshold value, remove noise included in the input voice signal based on the registered voice signal, and
acquire the reference voice signal by concatenating the input voice signal from which the noise has been removed with the registered voice signal.

7. The electronic apparatus of claim 1, wherein the instructions, when executed by the at least one processor individually or collectively, cause the electronic apparatus to identify the registered voice signal from among a plurality of registered voice signals based on a similarity between the plurality of registered voice signals and the input voice signal.

8. The electronic apparatus of claim 7, wherein the instructions, when executed by the at least one processor individually or collectively, cause the electronic apparatus to:
acquire a plurality of scores representing a quality of each of the plurality of registered voice signals, and
acquire a plurality of registered texts corresponding to each of the plurality of registered voice signals, and
identify the registered voice signal from among the plurality of registered voice signals based on the similarity, the plurality of scores representing the quality of each of the plurality of registered voice signals, and types of the plurality of registered texts.

9. The electronic apparatus of claim 1, wherein the instructions, when executed by the at least one processor individually or collectively, cause the electronic apparatus to, based on the registered voice signal not being identified, acquire the input voice signal as the reference voice signal.

10. The electronic apparatus of claim 8, wherein registration information comprising the plurality of registered voice signals and the plurality of scores is stored in the memory, and
Wherein the instructions, when executed by the at least one processor individually or collectively, cause the electronic apparatus to update the registration information by adding the reference voice signal to the plurality of registered voice signals and adding the score indicating the level of quality of the input voice signal to the plurality of scores.

11. The electronic apparatus of claim 1, wherein the instructions, when executed by the at least one processor individually or collectively, cause the electronic apparatus to:
acquire text in a first language corresponding to the input voice signal, and
wherein the input text is acquired by translating the text into a second language.

12. A method for controlling an electronic apparatus, the method comprising:
based on an input voice signal corresponding to an utterance of a user being received, acquiring quality information including a score indicating a level of quality of the input voice signal;
based on the score being below a first threshold value, identifying a registered voice signal among a plurality of registered voice signals for the user in stored memory;
based on the registered voice signal being identified, acquire a reference voice signal representing voice features of the user based on the registered voice signal; and
acquiring an output voice signal for the input voice signal based on input text corresponding to the input voice signal and the reference voice signal.

13. The method of claim 12, wherein the acquiring the quality information comprises acquiring the quality information based on at least one of a length of the input voice signal, a length of a voice portion included in the input voice signal, a length of a noise portion included in the input voice signal, or a frequency variation of the input voice signal.

14. The method of claim 12, further comprising:
based on the score being greater than or equal to the first threshold value, acquiring the input voice signal as the reference voice signal.

15. The method of claim 12, wherein the acquiring the reference voice signal comprises, based on the score being below the first threshold value and greater than or equal to a second threshold value that is less than the first threshold value, acquiring the reference voice signal by concatenating the input voice signal and the registered voice signal.

16. The method of claim 15, further comprising:
based on the score being below the second threshold value, acquiring the registered voice signal as the reference voice signal.

17. The method of claim 15, further comprising:
based on the score being below the second threshold value, removing noise included in the input voice signal based on the registered voice signal, and
acquiring the reference voice signal by concatenating the input voice signal from which the noise has been removed with the registered voice signal.

18. The method of claim 12, wherein the identifying the registered voice signal among the plurality of registered voice signals is based on a similarity between the plurality of registered voice signals and the input voice signal.

19. The electronic apparatus as claimed in claim 1, wherein the score is based on at least one of a length of the input voice signal being greater than or equal to an input voice threshold length value, a length of a voice portion included in the input voice signal being greater than or equal to a voice threshold length value, a length of a noise portion included in the input voice signal being greater than or equal to a noise threshold length value, or a frequency variation of the input voice signal being greater than or equal to a frequency variation threshold level.

20. A non-transitory computer-readable recording medium storing instructions that, when executed by at least one process of an electronic apparatus, cause the electronic apparatus to perform a method comprising:
based on an input voice signal corresponding to an utterance of a user being received, acquiring quality information including a score indicating a level of quality of the input voice signal;
based on the score being below a first threshold value, identifying a registered voice signal among a plurality of registered voice signals for the user stored in memory;
based on the registered voice signal being identified, acquire a reference voice signal representing voice features of the user based on the registered voice signal; and
acquiring an output voice signal for the input voice signal based on input text corresponding to the input voice signal and the reference voice signal.
